(19) United States
(12) Patent Application Publication
(10) Pub. No.: US 2016/0019643 A1
(43) Pub. Date: Jan. 21, 2016

(54) Invoice Swap Spreads

(71) Applicant: CME Group Inc., Chicago, IL (US)

(72) Inventors: John Labuszewski, Westmont, IL (US); Frederick Sturm, Chicago, IL (US); James Boudreault, Palatine, IL (US); Jonathan Kronstein, Elmhurst, IL (US); Daniel Grombacher, Evanston, IL (US); Agha Irtaza Mirza, New York, NY (US)

(21) Appl. No.: 14/334,990

(22) Filed: Jul. 18, 2014

(51) Int. Cl. G06Q 40/04

(52) U.S. Cl. CPC G06Q 40/04

(57) ABSTRACT

Stored invoice swap spread (IVSP) parameters may indicate that an IVSP conforming to the IVSP parameters includes a futures contract leg conforming to futures contract parameters and an interest rate swap (IRS) leg conforming to IRS parameters. A yield may be calculated based on an invoice price for a delivered debt instrument corresponding to a futures contract leg of an executed IVSP conforming to the IVSP parameters and based on the terms of the delivered debt instrument. A fixed rate for an IRS leg of the executed IVSP may be calculated based on the IRS parameters, the yield, and a price of the executed IVSP. Fixed rate payment dates for the IRS leg of the executed IVSP may be determined based on the IRS parameters and the terms of the delivered debt instrument.

### BACKGROUND

Investors often trade in financial products that are based on interest rates. Such trades may be performed as a hedge against changes in market interest rates or for other reasons. Examples of financial products that are based on interest rates include debt instruments (e.g., U.S. Treasury securities), futures contracts based on debt instruments, and interest rate swaps. Investors sometimes combine different types of interest-based financial products. However, there remains a need for improved systems and methods that facilitate trading such product combinations.

### SUMMARY

This Summary is provided to introduce a selection of concepts in a simplified form that are further described below in the Detailed Description. This Summary is not intended to identify key features or essential features of the invention.

In some embodiments, a computer system may store data that includes invoice swap spread (IVSP) parameters. The IVSP parameters may indicate that an IVSP conforming to the IVSP parameters includes a futures contract leg conforming to futures contract parameters and an interest rate swap (IRS) leg conforming to IRS parameters. The computer system may receive data describing terms, a delivery date and an invoice price for a delivered debt instrument corresponding to a futures contract leg of an executed IVSP conforming to the IVSP parameters. The computer system may also calculate a yield based on the invoice price and the terms of the delivered debt instrument. The computer system may additionally calculate a fixed rate for an IRS leg of the executed IVSP based on the IRS parameters, the yield, and a price of the executed IVSP. The computer system may further calculate fixed rate payment dates for the IRS leg of the executed IVSP based on the IRS parameters and the terms of the Ser. No. 16/782,151 delivered debt instrument. The computer system may transmit data that includes the fixed rate.

Embodiments include, without limitation, herein-described methods for processing data associated with invoice swap spreads, computer systems configured to perform such methods, and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIG. 2 is a timeline that showing events associated with an invoice swap spread according to some embodiments.

FIG. 3 shows operations performed by a computer system, according to some embodiments, in connection with establishing definitional parameters for invoice swap spreads and in connection with creation of invoice swap spreads conforming to those parameters.

FIG. 4 shows operations performed by a computer system, according to some embodiments, in connection with an executed invoice swap spread.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made.

Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment, and/or an embodiment combining software and hardware aspects. Furthermore, such aspects may take the form of a computer program product embodied as one or more non-transitory computer-readable storage media having computer-readable program code, or instructions, stored in or on that media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory, and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

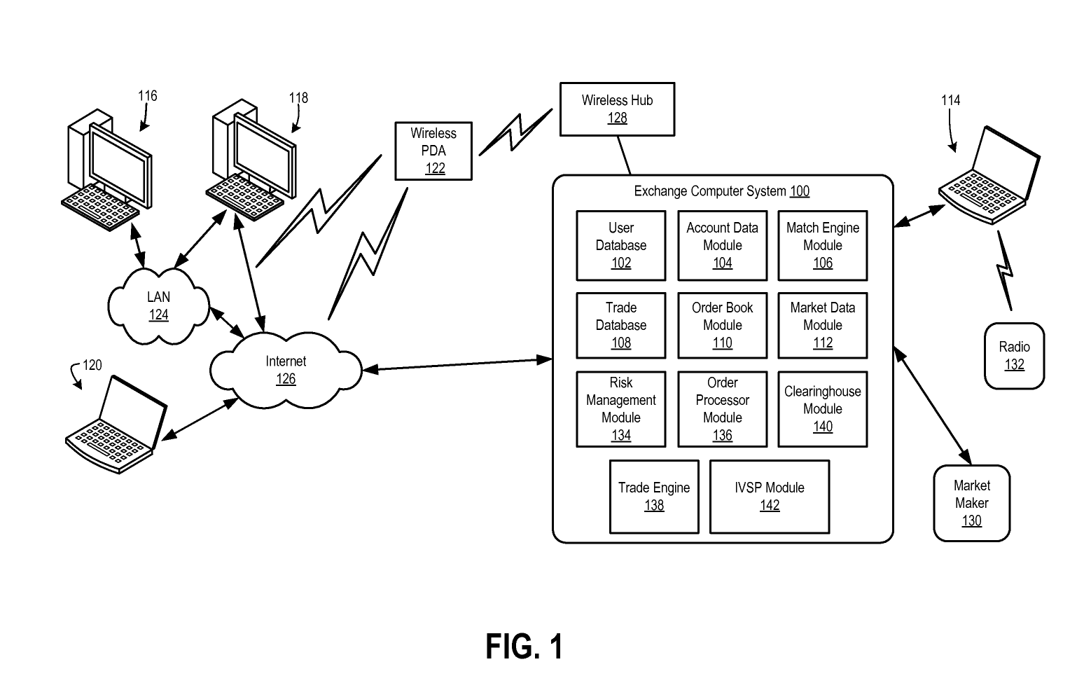

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with invoice swap spreads.

Computer system 100 can be operated by a financial product exchange and configured to perform operations of the exchange for, e.g., trading and otherwise processing data relating to various financial products. In addition to invoice swap spreads such as are described herein, financial products of the exchange may include, without limitation, futures contracts, options on futures contracts, other types of options, and other types of derivative contracts. Financial products traded or otherwise processed by the exchange may also include over-the-counter (OTC) products such as OTC forwards, OTC options, OTC swaps, etc. Financial products traded through the exchange may also or alternatively include other types of financial interests, including without limitation stocks, bonds and/or other securities (e.g., exchange traded funds), foreign currencies, and spot market trading of commodities.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options, and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100 regarding trades of invoice swap spreads, futures contracts, swaps, and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option, an invoice swap spread (IVSP), or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise and/or may select option grantors to fulfill obligations of exercising option holders. Module 140 may also be configured to perform other clearinghouse operations. As a further example, module 140 may maintain performance bond data with regard to clearing members and/or trading customers. As part of such operations, module 140 may store and maintain data regarding the values of various futures contracts, swaps, and other interests, determine mark-to-market and final settlement amounts, confirm receipt and/or payment of amounts associated with performance bond accounts, confirm satisfaction of delivery and other final settlement obligations, etc.

Exchange computer system 100 may include an IVSP module 142. Module 142 may generate, store, and process data associated with IVSPs. Various operations performed by module 142 in at least some embodiments are further described below.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN), or other mechanism for connecting computer devices. Also shown in FIG. 1 is a radio 132. The user of radio 132 (e.g., a trader or exchange employee) may transmit orders or other information to a user of computer device 114. The user of computer device 114 may then transmit those orders or other information to exchange computer system 100 using computer device 114.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links, or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish, or any other device for connecting a computer device to the Internet. Computers 116, 118, and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems, and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations associated with IVSP-related data.

Of course, numerous additional servers, computers, handheld devices, personal digital assistants, telephones, and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, and/or otherwise processes data associated with invoice swap spreads. As explained in further detail below, an invoice swap spread (“IVSP”) is a form of contract that includes two additional contracts as “legs.” A first of these legs may be a futures contract in which the deliverable is a debt security instrument. A second of those legs may be an interest rate swap (“IRS” or “swap”), the terms of which are based on a negotiated price for the IVSP and on terms of a debt instrument that is delivered in satisfaction of the futures contract leg. The following description of some embodiments refers to operations performed by IVSP module 142 and/or by other modules of computer system 100. In other embodiments, however, some or all of these operations may be performed by other modules of computer system 100 and/or by modules of one or more other computer systems.

“Futures contract” is a generic term for certain types of standardized derivative contracts that are traded through an exchange. For each type of futures contract, definitional parameters may define terms that apply to all future contracts of that type. Those terms may include, for example, an expiration date applicable to all contracts of that type, the manner in which contracts of that type are quoted and priced, times during which contracts of that type may be traded, and the manner in which contracts of that type may be settled, i.e., the manner in which obligations under a contract of that type may be satisfied. In many cases, definitional parameters for a type of futures contract define all terms of contracts of that type except for a price term. Parties wishing to enter into a futures contract may then submit orders that contain offer or bid values for that price term, with the orders then matched based on offer and bid values. Computer system 100 may then create, or “execute,” corresponding contracts based on the matched orders.

Definitional parameters for a type of futures contract also specify a particular subject matter, or “underlying,” for all contracts of that type. As but one example, an underlying for a type of futures contract may be an agricultural or other commodity. In such a case, definitional parameters may further specify that each futures contract of that type requires delivery of a predefined amount of that commodity on or about a predefined future date. As yet another example, an underlying may be a currency, a market index, an interest rate or other economic subject matter. In such a case, definitional parameters may specify payment on a predefined date of an amount computed from the value of the underlying on some future date.

There are two counterparties to a futures contract. A long counterparty (or “long”) usually refers to a futures contract party holding a long position, with that party also known as the buyer of the futures contract. For physically-settled futures contracts, a long may agree to pay a contract price in return for physical delivery of a contract underlying (e.g., a commodity) on a future date. A short counterparty (or “short”) usually refers to a futures contract party holding a short position, with that party also known as a seller of the futures contract. For physically-settled futures contracts, a short may agree to receive a contract price in return for providing physical delivery of the contract underlying on the future date.

Some types of futures contracts have a debt instrument as an underlying. If a debt instrument is issued by a governmental entity, it may also be known as a sovereign debt instrument. Examples of sovereign debt instruments include U.S. Treasury securities such as Treasury notes and Treasury bonds. A long to a debt instrument futures contract may be obligated to pay an invoice price at contract expiration in return for delivery of a contractually-specified type of debt instrument. Conversely, a short to such a futures contract may be obligated to deliver a contractually-specified type of debt instrument at contract expiration in return for payment of the invoice price. In many cases, a futures contract will not specify a single debt instrument that must be delivered. For example, the contract may require that the short deliver an instrument issued by a specific government, which has a defined notional value, that has a remaining duration within a defined range, and that has a minimum amount of time remaining until the instrument matures. A futures contract may also permit a short to deliver the instrument at any time the short chooses within a specified range of dates. The invoice price paid by the long to the short may be calculated in a manner as described below.

Debt instrument futures contracts include various types of U.S. Treasury futures contracts traded through CME Group Inc. of Chicago, Ill., U.S. For example, a 5-year Treasury note futures contract requires a short to deliver a U.S. Treasury note having a face value of $100,000. Definitional parameters for a type of 5-year Treasury note futures contract may specify an expiration month (e.g., March, June, September or December) in a specific year, a last trading day for contracts of that type (i.e., last business day of the expiration month), and a time interval during which delivery and invoice price payment must occur. Those definitional parameters may further specify deliverable grades of U.S. Treasury notes. For example, those parameters may specify that a delivered note must have an original maturity (measured from delivery) of not more than 5 years and three months and a remaining maturity (also measured from maturity) of not less than 4 years and 2 months. Other types of Treasury futures contracts may have similar structures, but may differ based on expiration date, notional value of delivered instrument, and/or deliverable grades of instruments.

Notably, definitional parameters for a Treasury futures contract type may not define a coupon interest rate for deliverable grades of securities. Because of this, and because of the range of maturity dates that may exist for deliverable grade instruments, a conversion factor is used when calculating an invoice price that a Treasury futures contract long pays the short upon delivery of the underlying Treasury note. In particular the invoice price paid under a Treasury futures contract may be as set forth in Equation 1:

P_inv=(SF*SP*CF)+AI Equation 1:

In Equation 1, “P_inv” is the invoice price in U.S. dollars. “SF” is a scalar factor that accounts for differences in sizes of notionals for different types of Treasury futures contracts. For example, SF may have a value of $1000 for Treasury futures contracts having a $100,000 notional and a value of $2000 for Treasury futures contracts having a $200,000 notional. “SP” is a settlement price for the futures contract. The settlement price may be calculated in a manner that is specified by definitional parameters and that is based on the prices at which contracts of the same type (e.g., having same notional, same expiration date, etc.) were trading as of specific time. For a Treasury futures contract in which the short declares an intent to deliver prior to the last trading day for contracts of the same type, the settlement price may be based on trading prices on the day in which the declaration is made. For a Treasury futures contract in which a short declares an intent to deliver on or after the last trading day, the settlement price may be based on trade prices on that last trading day.

The settlement price SP, as well as trading prices for Treasury futures contracts, may be quoted in terms of basis points (with one basis point equaling 0.01%). Notably, the settlement price SP used to calculate an invoice price for a Treasury futures contract may be different from the original price of that contract (e.g., the bid and offer prices matched to create the contract). Through the marking-to-market process, however, accounts of the long and short parties may be periodically adjusted to reflect a difference between that original contract price and the value of that contract as reflected by ongoing trading activity.

“CF” in Equation 1 is a conversion factor. The conversion factor may be different for every instrument. A CF associated with a particular Treasury security is calculated as a percent of par at which that Treasury security would trade, in view of its coupon and maturity, to yield 6%. Tables of conversion factors are periodically calculated and published by CME Group for numerous Treasury securities. A 6% coupon is arbitrary and is generally established at levels reflective of current market conditions. However, conditions do change and a different value could be used as a foundation for conversion factor computation.

The “AI” term in Equation 1 represents accrued interest on the delivered instrument in the current coupon period. Treasury securities pay coupon interest bi-annually. The coupon interest payment for a Treasury security, per $1000 of par, is thus (c/200)×$1000, where “c” is the coupon interest rate per annum. Accrued interest on a date T is equal to (c/200)×$1000×(DT/Dc), where DT is the actual number of days from the beginning of the current coupon period to date T and Dc is the actual number of days in the current coupon period.

“Cheapest-to-deliver” (“CTD”) is another concept that is often relevant to debt instrument futures contracts. By comparing the prevailing price of a Treasury security in the cash markets with the invoice amount one would receive by delivering that security on a futures contract, one may calculate the explicit gain or loss realizable through the delivery process. If one were to make a similar analysis for all eligible-for-delivery instruments, one may identify the so-called CTD instrument as the one which generates the most favorable outcome (to the short) upon delivery.

An interest rate swap (IRS or “swap”) is a type of contract in which one of the counterparties agrees to pay a fixed rate of interest, on contractually-specified dates over a contractually-specified duration of the swap, on a notional amount. The fixed rate payor further agrees to receive a floating rate of interest, on contractually-specified dates over the duration of the swap, on that same notional. The other counterparty to the swap has converse obligations, i.e., to make the floating rate payments and to receive the fixed rate payments. Although swap positions can be characterized as long or short, those positions may alternately be characterized based on what a party is paying or receiving (e.g., fixed rate payor or floating-rate receiver). The fixed rate is typically negotiated by the parties to the swap. The floating rate is typically defined by the swap. An example of such a floating rate is the 3-month LIBOR (London Interbank Offered Rate).

In some embodiments, computer system 100 may generate and store data that includes definitional parameters for a type of IVSP. A long position in an IVSP of that type may include a long position in a futures contract and a fixed rate payor (floating rate receiver) position in a swap. Conversely, a short position in an IVSP of that type may include a short position in a futures contract and a fixed rate receiver (floating rate payor) position in a swap. In some embodiments, IVSP prices may be quoted in basis points, with an IVSP price representing an interest rate difference (or “spread”) that is used when determining the fixed rate payable under the swap leg. An IVSP price may be positive or negative.

In at least some embodiments, IVSPs may be traded through computer system 100 in a manner similar to other exchange-traded products. Parties wishing to acquire long IVSP positions may submit data that indicate bids for IVSPs and prices at which those parties are willing to enter into long IVSP positions. Parties wishing to acquire short IVSP positions may submit data that indicate offers for IVSPs and prices at which those parties are willing to enter into short IVSP positions. Computer system 100 may match bids and offers based on price and create IVSPs at those matched prices.

For convenience, subsequent discussions may describe an IVSP and its legs in terms of actions and obligations of the counterparties to a particular IVSP. In some embodiments, however, and similar to other types of exchange-traded contracts, one of the counterparties to every IVSP may be a clearinghouse (e.g., a clearinghouse of the exchange operating computer system 100). For each matched bid-offer pair, computer system 100 may thus create a first IVSP between the matched bidder as a long and a clearinghouse as a short, as well as an identical second IVSP between the matched offeror as a short and the clearinghouse as a long.

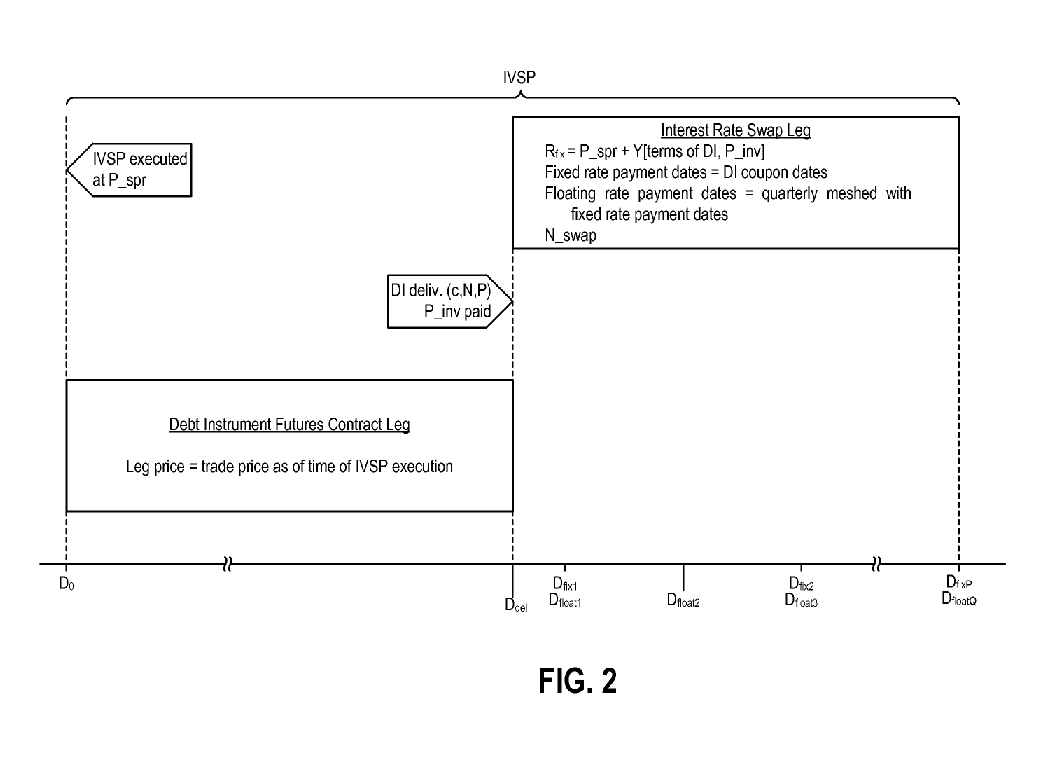

FIG. 2 is a timeline that further shows events associated with an IVSP according to some embodiments. On date D₀, an IVSP is executed as a result of matching a bid and an offer. The matched price of the executed IVSP is P_spr. Also at date D₀, a debt instrument futures contract leg of the executed IVSP begins. The price of that futures contract leg is set to the last trade price, as of the time on D₀ that the IVSP bid and offer were matched, for debt instrument futures contracts of the same type.

On a delivery date D_{del}, the short to the debt instrument futures contract leg (which party is also the IVSP short) delivers a debt instrument (DI) in fulfillment of the futures contract leg delivery requirements. The delivered instrument has a coupon interest rate c, a par value N, and P scheduled coupon interest payments. Also on date D_{del}, the long to the futures contract leg pays the invoice price P_inv to the short.

In addition to being the end of the futures contract leg, date D_{del} is the beginning of the swap leg. Terms of the swap leg are based on delivered instrument in the futures contract leg, on the invoice price P_inv, and on the IVSP price P_spr. The fixed rate under the swap leg is the sum of the contract price P_spr and a yield Y. Yield Y is calculated as the yield of the delivered instrument, based on the remaining duration of that instrument as of D_{del}, when purchased at price P_inv. Yield calculation is further described below.

The swap leg has a notional N_swap. The amount of notional N_swap may be based on a notional value of the futures contract leg, an interest rate sensitivity (e.g., a DV01 value) of the futures contract leg, and an interest rate sensitivity (e.g., a DV01 value) of the swap leg. Calculation of swap leg notional value is also discussed below.

Under the swap leg, and assuming a biannual coupon for the delivered instrument DI, the IVSP long will make P fixed rate payments of R_{fix}×N_swap to the IVSP short. The floating rate R_{float} under the swap leg may be, e.g., a published short term rate such as the 3-month LIBOR. The IVSP short will make Q floating rate payments in the amount of R_{float}×N_swap. The dates D_{fix1}, D_{fix2}, . . . , D_{fixP} of the fixed rate payments of the swap leg are scheduled to coincide with the dates on which the remaining P coupon payments are due under the delivered instrument DI. The floating rate payment dates D_{float1}, D_{float2}, . . . D_{floatQ} occur quarterly and end on the last fixed payment date (i.e., D_{fixP}=D_{floatQ}). The example of FIG. 2 assumes that the time between D_{del} and D_{fix1} is less than three months. In that case, the first floating rate payment date D_{float1} coincides with the first fixed rate payment date D_{Fix1}, Q=2P, and the amounts of the first fixed rate and floating rate payments are prorated to account for the stub period between D_{del} and D_{fix1}. If there are more than three months between D_{del} and D_{fix1}, the first floating rate payment would be due on a date D_{float1} three months prior to D_{fix1}, D_{fix1}=D_{float2}, and Q=2P+1. In this case, the first floating rate payment would be prorated to account for a stub period between D_{del} and D_{float1} and the first fixed rate payment would be prorated to account for a stub period between D_{del} and D_{fix1}.

Although the example of FIG. 2 assumes that delivered instrument DI has a biannual coupon payment schedule similar to that of U.S. Treasury securities, this need not be the case. In other embodiments, a delivered instrument may have a different schedule of coupon payments. In such an embodiment, the swap leg fixed rate payments can be set to coincide with the coupon payment dates and the floating rate payments can be scheduled on those dates, at appropriate times between the fixed rate payments, and (if appropriate) prior to the first fixed rate payment.

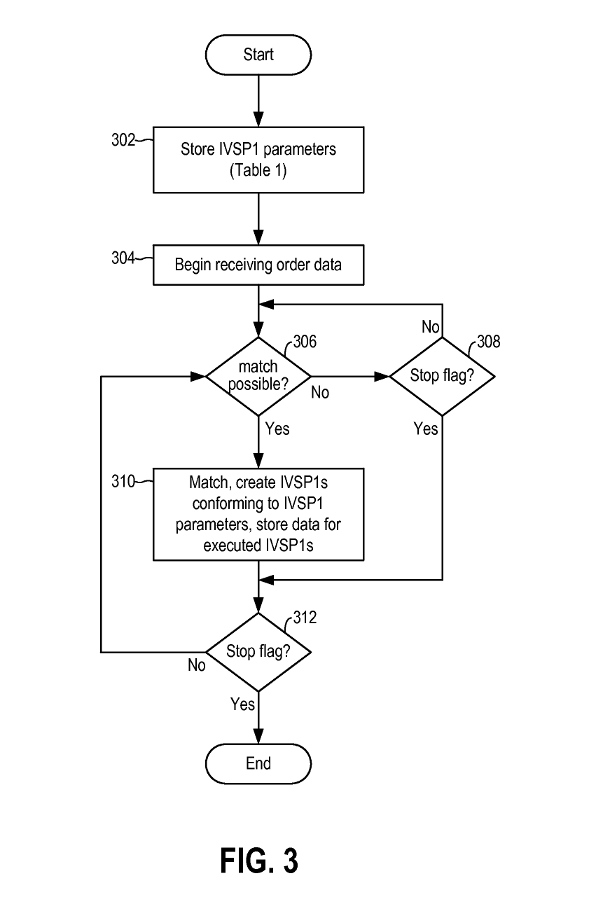

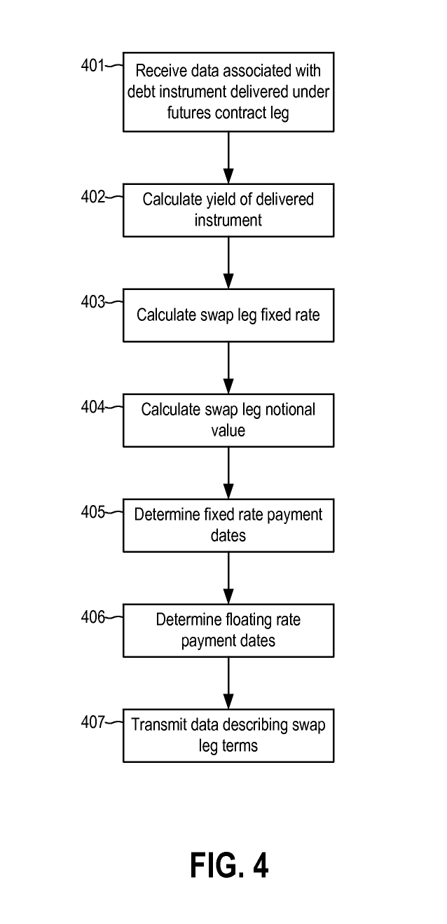

FIGS. 3 and 4 are flow charts showing operations performed in some embodiments to process data associated with IVSPs. For convenience, the operations of FIGS. 2 and 3 are described using a hypothetical type of IVSP known as an ISVP1. An IVSP1 includes a hypothetical type of U.S. Treasury futures contract (TFC1) as a first leg. A TFC1 is structured in a manner similar to that described above (e.g., an invoice price is calculated using Equation 1). Persons of skill in the art will recognize, in view of the disclosure provided herein, how the calculations and other operations described below may be adapted in connection with an IVSP under which a different type of debt instrument futures contract is a leg of that IVSP. In some such alternate embodiments, a debt instrument futures contract leg may require delivery of a debt instrument having a different coupon payment schedule and/or other terms that differ from terms of U.S. Treasury securities.

FIG. 3 shows operations performed by computer system 100 in connection with establishing definitional parameters for IVSP1s and in connection with creation of IVSP1s conforming to those parameters. In step 302 of FIG. 3, IVSP module 142 stores data that includes IVSP1 parameters. An IVSP1 is an IVSP conforming to the IVSP1 parameters. The IVSP1 parameters indicate that an IVSP1 includes a futures contract leg that conforms to certain futures contract parameters and an interest rate swap (IRS) leg that corresponds to certain IRS parameters. The IVSP1 parameter data may further include those futures contract parameters and IRS parameters, explicitly or by using pointers to data stored elsewhere. Table 1 summarizes a portion of the IVSP1 parameter data stored in step 302

TABLE 1
IVSP1 Parameters

| | |
|---|---|
| IVSP1 | Long: futures contract leg = long in futures contract |
| | conforming to FUT parameters; IRS leg = IRS fixed |
| | rate payor, floating rate receiver in IRS leg conforming |
| | to IRS parameters |
| | Short: futures contract leg = short in futures contract |
| | conforming to FUT parameters; IRS leg = IRS fixed |
| | rate receiver, floating rate payor in IRS leg conforming |
| | to IRS parameters |
| FUT | TFC1; <pointer to TFC1 definitional parameter data> |
| parameters | |
| IRS | Currency: USD |
| parameters | Notional: DV01-adjusted notional of futures contract leg |
| | Effective date: D_{del} of futures contract leg |
| | Business day(s): New York and London |
| | Business day convention: following |
| | Termination date: actual maturity date of delivered instrument |
| | under futures contract leg |
| | Fixed rate payment dates: semiannual, coincident with actual |
| | coupon payment dates of delivered instrument under |
| | futures contract leg |
| | Fixed rate: Yield = (F(terms of delivered instrument under |
| | futures contract leg, P_inv corresponding to futures |
| | contract leg)) + P_spr |
| | Fixed rate day count: 30/360 |
| | Floating rate payment dates: quarterly, coterminous with |
| | maturity of delivered instrument under futures contract |
| | leg (subject to following business day convention) |
| | Floating rate: USD-LIBOR-BBA |
| | Floating day count: actual 360 |
| | Compounding: no |

The data represented by the first row of Table 1 indicates that a long IVSP1 position includes a long position in a futures contract conforming to certain future contract parameters FUT and fixed rate payor (floating rate receiver) position in an interest rate swap conforming to certain IRS parameters. The first row data further indicates that a short IVSP1 position includes a short position in a futures contract conforming to the FUT parameters and fixed rate receiver (floating rate payor) position in a swap conforming to the IRS parameters.

The data represented by the second row of Table 1 provides the futures contract parameters. In this example, that data includes an indication that a futures contract leg of an IVSP1 is a TFC1 type of Treasury futures contract. The futures contract parameters further include the definitional parameters for TFC1 Treasury futures contracts. In the present example, TFC1 Treasury futures contracts may also be traded outright (i.e., not as part of a spread or other combination). Accordingly, module 142 includes the TFC1 parameters in the IVSP1 parameters by including a pointer to separately stored TFC1 parameter data. The TFC1 parameters may include, e.g., a notional (e.g., a par value for a deliverable U.S. Treasury security), an expiration date, data specifying deliverable grades of securities, pricing convention, minimum tick size, data defining how interim settlement prices (for marking to market) and final settlement prices are determined, a date window for delivery, an algorithm for calculating invoice price, etc.

The data represented by the third row of Table 1 provides the IRS parameters. In this example, those parameters indicate that a swap leg of an IVSP1 will be based on U.S. Dollars as the currency, will be based on New York and London business days, and will employ a following business day convention. The IRS parameters include data indicating that a swap leg will have a notional that is a DV01-adjusted notional of the futures contract leg, an effective date that is the delivery date (D_{del}) of the futures contract leg, a termination date that is the actual maturity date of the delivered instrument corresponding to the futures contract, and fixed rate payment dates that coincide with the actual coupon payment dates of the delivered instrument. The IRS parameters further include data indicating that the swap leg fixed rate is equal to a yield value plus the price (P_spr) of the IVSP1, and further provide an algorithm (shown as a function “F”) for calculating the yield based on the terms of the delivered instrument under the futures contract leg and based on the invoice price (P_inv) paid for that delivered instrument. The IRS parameters further include data indicating the fixed rate day count as 30/360, data indicating the floating rate payments are quarterly and coterminous with the maturity of the delivered instrument under the futures contract leg, data indicating the source of the floating rate, data indicating a floating rate day count of 360 (except for any stub period), and data indicating no compounding.

In step 304, order book module 110 of exchange computer system 100 begins receiving order data from parties desiring to enter into IVSP1s. Computer system 100 may continue to receive such order data until the operations of FIG. 3 end. The received order data includes buy order data from parties wishing to buy (i.e., acquire long positions in) IVSP1s and sell order data from parties wishing to sell (i.e., acquire shorts positions in) IVSP1s. The buy order data includes bid pricing data indicating contract prices at which the submitters are willing to buy IVSP1s. The sell order data includes offer pricing data indicating contract prices at which the submitters are willing to sell IVSP1 s. In at least some embodiments, and as described herein, the price of an IVSP1 spread may represent a component of an interest rate for a swap leg of an IVSP1.

In step 306, match engine module 106 of computer system 100 determines if any of the received buy orders can be matched with any of the received sell orders. Match engine module 106 may perform this determination based on the bid and offer prices in those orders. This matching may be performed on a first-in first-out (FIFO) basis or on some other basis and using conventional order matching algorithms used in connection with orders for existing types of futures contracts and other products. If no matches are possible, and as shown by the “no” branch from step 306, computer system 100 determines in step 308 whether a “stop” flag has been set. Such a flag may be set, for example, if the close of trading time and date for IVSP1s has been reached. If the flag is not set, and as shown by the “no” branch from step 308, step 306 is repeated. If the stop flag has been set, and as shown by the “yes” branch from step 308, the operations of FIG. 3 end.

If computer system 100 determines in step 306 that a match is possible, and as shown by the yes branch from step 306, the match is performed in step 310. As part of step 310, computer system 100 stores data for executed IVSP1s corresponding to the matched buy and sell orders. For each IVSP1 buy order matched to an IVSP1 sell order, at least two IVSP1s are created. A first of those IVSP1s is between the matched buyer and a clearinghouse of the exchange. The buyer is the long counterparty to that IVSP1 and the clearinghouse is the short counterparty to that IVSP1. A second of those IVSP1s is between the matched seller and the clearinghouse. The seller is the short counterparty to that IVSP1 and the clearinghouse is the long counterparty to that IVSP1. The prices for those two IVSP1 s, which are based on the matched orders, are the same. The matched buyer and seller may not know each other's identities. As part of step 310, clearinghouse module 140 of computer system 100 stores the contract price for each of the executed IVSP1 s.

In step 312, computer system 100 again determines if the stop flag has been set. If not, and as indicated by the “no” branch from step 312, computer system 100 returns to step 306. If the stop flag has been set, and as indicated by the “yes” branch from step 312, the operations of FIG. 3 end.

FIG. 4 shows operations performed by computer system 100 in connection with each executed IVSP1 that results from a match in step 310 of FIG. 3. Computer system 100 may simultaneously perform operations of FIG. 4 in numerous independent program threads, with each thread corresponding to a matched pair of buy and sell orders. For example, if a buy order for one IVSP1 is matched with a sell order for one IVSP1, computer system 100 may perform the operations of FIG. 4 in one program thread in connection with an account of the buy order submitter and separately perform the operations of FIG. 4 in another program thread in connection with an account of the sell order submitter. For convenience, the operations of FIG. 4 will be described in the context of a single IVSP1. In some cases, however a single order matching may result in numerous pairs of IVSP1 s. For example, a buy order for 500 IVSP1s might be matched against a sell order for 500 IVSP1 s. In such a case, computer system 100 might perform the operations of FIG. 4 in one program thread for the resulting 500 IVSP1 long positions of the buy order submitter and separately perform the operations of FIG. 4 in another program thread for the resulting 500 IVSP1 short positions of the sell order submitter.

In step 401 of FIG. 4, computer system 100 receives data associated with a debt instrument delivered under the futures contract leg of the IVSP1 spread. The received data includes a delivery date D_{del}, an invoice price P_inv, and data describing terms of the delivered instrument. Those terms include the coupon interest rate, the number of coupon payments remaining, the coupon payment dates, and the maturity date of the delivered instrument. Because U.S. Treasury securities pay according to published schedules, data providing the number of coupon payments remaining and coupon payment dates may be received from a lookup table that provides such information based on a CUSIP (Committee on Uniform Securities Identification Procedures) number of the security.

In step 402, module 142 calculates a yield Y for the delivered instrument based on the data received in step 401. In some embodiments, the yield Y is calculated using Equation 2.

P_inv(bps)=((c/2)×(1+(Y/200))^{-sa})+Σ_{1=2 . . . P}[(c/2)×(1+(Y/200))^{-(s+bi+ni)}]+(100×(1+(Y/200))^{-(s+bP+nP)}) Equation 2:

The value “P_inv(bps)” in Equation 2 is the invoice amount for the delivered instrument, in basis points. This value can be derived from an invoice price calculated using Equation 1 by dividing that invoice price by the contract scalar factor used in Equation 1. The values “c”, “P,” “s”, “sa”, “bi,” “ni,” “bP,” and “nP” in Equation 2 relate to coupon payments under the delivered instrument. The value “c” is the coupon payment rate. The value “P” is the number of coupon payments from D_{del} to the delivered instrument maturity date. The value “s” is s_num divided by s_denom, where s_num is the number of days from D_{del} to the next nominal coupon interest date, and where s_denom is the number of days from the last nominal coupon interest date before D_{del} to the next following nominal coupon interest date. The value “sa” is sa_num divided by sa_denom, where sa_num is the number of days from D_{del} to the actual coupon interest date next following D_{del}, and where sa_denom is the number of days from the last nominal coupon interest date before D_{del} to the next following nominal coupon interest date. A “nominal” date is a date on which a payment is scheduled to occur; an “actual” date is the date on which a payment occurs when a nominal date is not a business day. The value “bi” is bi_num divided by bi_denom, where bi_num is the number of days from nominal coupon interest date i−1 to actual coupon interest date i, and where bi_denom is the number of days from nominal coupon interest date i−1 to nominal coupon interest date i. The value “ni” is the number of coupon interest payments from (and including) D_{del} to (and not including) nominal coupon interest date i, excluding the first coupon interest payment following D_{del}. The value “bP” is bP_num divided by bP_denom, where bP_num is the number of days from nominal coupon interest date P−1 to actual coupon interest date P, and where bP_denom is the number of days from nominal coupon interest date P−1 to nominal coupon interest date P. The value “nP” is the number of coupon interest payments from (and including) D_{del} to (and not including) nominal coupon interest date P, excluding the first coupon interest payment following D_{del}.

Other formulas could be used to calculate the yield value Y. For example, the “PRICE” function in the EXCEL spreadsheet software available from Microsoft Corporation calculates a yield value that accounts for variations in coupon payment dates.

After step 402, module 142 proceeds to step 403 and calculates a fixed rate for the swap leg of the IVSP1. In some embodiments that fixed rate R_{fix} is calculated using Equation 3.

R_{fix}=Y+(P_{—}spr/100) Equation 3:

The value “Y” in Equation 3 is the yield calculated in step 402. The value “P_spr” in price at which the IVSP1 was executed, in basis points. As part of step 403, module 142 may access previously stored data that includes a P_spr value for the IVSP1.

In step 404, module 142 determines a notional value for the swap leg of the IVSP1. In some embodiments, the notional of the swap leg is adjusted relative to the futures leg so that the interest rate sensitivity of the swap leg is approximately equal to the interest rate sensitivity of the futures leg. In at least some such embodiments, this adjustment is based on DV01 values for the futures and swap legs, with the swap leg notional N_swap calculated according to Equations 4 through 6.

N_swap=N_fut×(DV01_{FUT}/DV01_{SWAP}) Equation 4:

The value “N_fut” in Equation 4 is the notional amount of the futures contract leg of the IVSP1. The value “DV01_{FUT}” in Equation 4 is the DV01 value of that futures contract leg and can be approximated using Equation 5 below. The value “DV01_{SWAP}” in Equation 4 is the DV01 value of the swap leg of the IVSP1 and can be approximated using Equation 6 below.

DV01_{FUT}=0.01×SF×(1/200)×{(c/2)×(−1)×[sa×(1+(Y/200))^{-sa-1}+Σ_{i=1 . . . P}((bi+ni+s)×(1+(Y/200))^{-(bi+ni+s)-1)})]+100×((bP+nP+s)×(1+(Y/200))^{-(bP+nP+s)-1})} Equation 5:

The value “SF” in Equation 5 is the contract scalar factor applicable to the futures contract leg. Contract scalar factor SF was described above in connection with Equation 1. The values “c,” “sa,” “s,” “P,” “bi,” “ni,” “bP,” and “nP” have the same meanings that were explained in connection with Equation 2.

DV01_{SWAP}=0.01×(1/100)×Σ_{k=1 . . . P}{[(dk/360)/(1+((dk/360)×(R_{fix}/100)]×Σ_{i=k . . . P}[ci/(Π_{j=1 . . . i}(1+((dj/360)×(R_{fix}/100)))]} Equation 6:

The value “P” in Equation 6 is the number of fixed rate payments in the swap leg. The value “d_” in Equation 6 represents the number of days in interest period associated with the _th one of those fixed rate payments, where “_” is one of the iteration counters used in Equation 6. The value “ci” in Equation 6, for i=1 to i=P−1, is (di/360)×R_{fix}. For i=P, ci=cP=(100+(di/360)×R_{fix}).

In step 405, module 142 determines the dates of the fixed rate payments under the swap leg. In some embodiments, and as explained above, the fixed rate payment dates under the swap leg coincide with the coupon interest payment dates under the delivered instrument of the futures leg.

In step 406, module 142 determines the dates of the floating rate payments under the swap leg. In some embodiments, and as explained above, the floating rate payments occur on the fixed rate payment dates, on dates midway between the fixed rate payment dates, and (if there is sufficient time between the start of the swap leg and the first fixed rate payment) on a date that precedes the first fixed rate payment by one half the number of days between adjacent fixed rate payments.

In step 407, module 142 transmits data describing the swap leg terms to clearinghouse module 140 and/or to other modules of computer system 100 and/or to one or more other computer systems. The transmitted data may include values for the swap leg notional (N_swap), the fixed interest rate (R_{fix}), the fixed rate payment due dates and the floating rate payment due dates. This data may then be used in further operations. Those further operations may include, e.g., determining whether swap leg obligations have been performed, performing mark-to-market operations in connection with the swap leg, etc.

Some operations of computer system 100 associated with an executed IVSP1 are not shown in FIG. 4. Prior to expiration of the futures contract leg of an IVSP1, for example, computer system 100 may track the values of that futures contract leg and periodically adjust the accounts of counterparties to that futures contract leg based on changes in market value for other futures contracts of the same type. This operation, known as marking to market, is similar to known mark-to-market operations performed in connection with other types of futures contracts. After expiration of the futures contract leg of an IVSP1, and prior to the expiration of the swap leg of that IVSP1, computer system 100 may similarly track the value of that swap leg (relative to the market) and perform marking to market in a manner similar to that employed in connection with other types of cleared swaps.

Although the preceding description of FIGS. 3 and 4 focused on operations performed in connection with a single type of IVSP, computer system 100 could generate and store data representing definitional parameters for each of numerous types of IVSPs. Computer system 100 could perform operations, similar to those described herein, as to each of those IVSP types and as to individual instances of each of those IVSP types.

Additional embodiments include numerous variations on the exemplary features described thus far. As but one example, the order of certain steps described in connection with FIG. 4 can be rearranged. An exchange might, for example, precalculate swap terms in advance of delivery under a futures leg of an IVSP. In this regard, the definitional parameters applicable to a futures leg may limit the number of possible instruments that might be delivered. As delivery dates approach, market conditions may be such that one or more of those possible instruments will stand out as a CTD candidate. Moreover, it is typically in the interest of a debt instrument futures contract short to deliver at either the beginning or the end of the allowable delivery interval. Thus, computer system 100 could calculate swap leg terms for each of the likely CTD instruments, for delivery at the beginning or end of the futures leg delivery interval, and across a range of possible settlement prices for the futures leg, for each IVSP prior to futures leg expiration.

As another example of additional embodiments, the underlying for a futures leg of an IVSP need not be a U.S. Treasury security. In some embodiments, the futures leg may be a type of futures contract in which the underlying is some other type of sovereign debt instrument. The underlying debt instrument may not have fixed rate payments at equal intervals, may have more or fewer than two fixed rate payments per year, etc.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
storing, by a computer system, data including invoice swap spread (IVSP) parameters, wherein the IVSP parameters indicate that an IVSP conforming to the IVSP parameters includes a futures contract leg conforming to futures contract parameters and an interest rate swap (IRS) leg conforming to IRS parameters;
receiving, by the computer system, data describing terms, a delivery date and an invoice price for a delivered debt instrument corresponding to a futures contract leg of an executed IVSP conforming to the IVSP parameters;
calculating, by the computer system, a yield based on the invoice price and the terms of the delivered debt instrument;
calculating, by the computer system, and based on the IRS parameters, the yield, and a price of the executed IVSP, a fixed rate for an IRS leg of the executed IVSP;
calculating, by the computer system, and based on the IRS parameters and the terms of the delivered debt instrument, fixed rate payment dates for the IRS leg of the executed IVSP; and
transmitting, by the computer system, data including the fixed rate.

2. The method of claim 1, further comprising calculating, by the computer system, a notional value for the IRS leg of the executed IVSP, and wherein the transmitting includes transmitting data indicating the notional value.

3. The method of claim 2, wherein calculating the notional value comprises calculating the notional value based on a notional value of the futures contract leg of the executed IVSP, a value corresponding to an interest rate sensitivity of the futures contract leg of the executed IVSP, and a value corresponding to an interest rate sensitivity of the IRS leg of the executed IVSP.

4. The method of claim 3, wherein the notional value of the IRS leg of the executed IVSP is based on the notional value of the futures contract leg of the executed IVSP multiplied by the ratio DV01_{FUT}/DV01_{IRS}, where DV01_{FUT} is a DV01 value for the futures contract leg of the executed IVSP and DV01_{IRS} is a DV01 value for the IRS leg of the executed IVSP.

5. The method of claim 1, further comprising:
receiving, at the computer system, buy order data representing a bid price for an IVSP conforming to the IVSP parameters and sell order data representing an offer price for an IVSP conforming to the IVSP parameters;
matching, by the computer system, the buy order data and the sell order data; and
storing, by the computer system and as a result of the matching, data representing the executed IVSP.

6. The method of claim 1, wherein the futures contract parameters specify a sovereign debt instrument as an underlying.

7. The method of claim 1, wherein the fixed rate payment dates for the IRS leg of the executed IVSP coincide with payment dates of the delivered debt instrument.

8. One or more non-transitory computer-readable media storing computer executable instructions that, when executed, cause a computer system to perform operations that include:
storing data including invoice swap spread (IVSP) parameters, wherein the IVSP parameters indicate that an IVSP conforming to the IVSP parameters includes a futures contract leg conforming to futures contract parameters and an interest rate swap (IRS) leg conforming to IRS parameters;
receiving data describing terms, a delivery date and an invoice price for a delivered debt instrument corresponding to a futures contract leg of an executed IVSP conforming to the IVSP parameters;
calculating a yield based on the invoice price and the terms of the delivered debt instrument;
calculating, based on the IRS parameters, the yield, and a price of the executed IVSP, a fixed rate for an IRS leg of the executed IVSP;
calculating, based on the IRS parameters and the terms of the delivered debt instrument, fixed rate payment dates for the IRS leg of the executed IVSP; and
transmitting data including the fixed rate.

9. The one or more non-transitory computer-readable media of claim 8, further comprising stored computer executable instructions that, when executed, cause a computer system to perform operations that include:
calculating a notional value for the IRS leg of the executed IVSP, and wherein the transmitting includes transmitting data indicating the notional value.

10. The one or more non-transitory computer-readable media of claim 9, wherein calculating the notional value comprises calculating the notional value based on a notional value of the futures contract leg of the executed IVSP, a value corresponding to an interest rate sensitivity of the futures contract leg of the executed IVSP, and a value corresponding to an interest rate sensitivity of the IRS leg of the executed IVSP.

11. The one or more non-transitory computer-readable media of claim 10, wherein the notional value of the IRS leg of the executed IVSP is based on the notional value of the futures contract leg of the executed IVSP multiplied by the ratio DV01_{FUT}/DV01_{IRS}, where DV01_{FUT} is a DV01 value for the futures contract leg of the executed IVSP and DV01_{IRS} is a DV01 value for the IRS leg of the executed IVSP.

12. The one or more non-transitory computer-readable media of claim 8, further comprising stored computer executable instructions that, when executed, cause a computer system to perform operations that include:
receiving buy order data representing a bid price for an IVSP conforming to the IVSP parameters and sell order data representing an offer price for an IVSP conforming to the IVSP parameters;
matching the buy order data and the sell order data; and
storing, as a result of the matching, data representing the executed IVSP.

13. The one or more non-transitory computer-readable media of claim 8, wherein the futures contract parameters specify a sovereign debt instrument as an underlying.

14. The one or more non-transitory computer-readable media of claim 8, wherein the fixed rate payment dates for the IRS leg of the executed IVSP coincide with payment dates of the delivered debt instrument.

15. A computer system comprising:
at least one processor; and
at least one non-transitory memory, wherein the at least one non-transitory memory stores instructions that, when executed, cause the computer system to perform operations that include
storing data including invoice swap spread (IVSP) parameters, wherein the IVSP parameters indicate that an IVSP conforming to the IVSP parameters includes a futures contract leg conforming to futures contract parameters and an interest rate swap (IRS) leg conforming to IRS parameters,
receiving data describing terms, a delivery date and an invoice price for a delivered debt instrument corresponding to a futures contract leg of an executed IVSP conforming to the IVSP parameters,
calculating a yield based on the invoice price and the terms of the delivered debt instrument,
calculating, based on the IRS parameters, the yield, and a price of the executed IVSP, a fixed rate for an IRS leg of the executed IVSP,
calculating, based on the IRS parameters and the terms of the delivered debt instrument, fixed rate payment dates for the IRS leg of the executed IVSP, and
transmitting data including the fixed rate.

16. The computer system of claim 15, wherein the at least one non-transitory memory stores instructions that, when executed, cause the computer system to perform operations that include
calculating a notional value for the IRS leg of the executed IVSP, and wherein the transmitting includes transmitting data indicating the notional value.

17. The computer system of claim 16, wherein calculating the notional value comprises calculating the notional value based on a notional value of the futures contract leg of the executed IVSP, a value corresponding to an interest rate sensitivity of the futures contract leg of the executed IVSP, and a value corresponding to an interest rate sensitivity of the IRS leg of the executed IVSP.

18. The computer system of claim 17, wherein the notional value of the IRS leg of the executed IVSP is based on the notional value of the futures contract leg of the executed IVSP multiplied by the ratio DV01_{FUT}/DV01_{IRS}, where DV01_{FUT} is a DV01 value for the futures contract leg of the executed IVSP and DV01_{IRS} is a DV01 value for the IRS leg of the executed IVSP.

19. The computer system of claim 15, wherein the at least one non-transitory memory stores instructions that, when executed, cause the computer system to perform operations that include
receiving buy order data representing a bid price for an IVSP conforming to the IVSP parameters and sell order data representing an offer price for an IVSP conforming to the IVSP parameters,
matching the buy order data and the sell order data, and
storing, as a result of the matching, data representing the executed IVSP.

20. The computer system of claim 15, wherein the futures contract parameters specify a sovereign debt instrument as an underlying.

21. The computer system of claim 15, wherein the fixed rate payment dates for the IRS leg of the executed IVSP coincide with payment dates of the delivered debt instrument.
